(19) United States
(12) Patent Application Publication
(10) Pub. No.: US 2015/0015245 A1
(43) Pub. Date: Jan. 15, 2015

(54) MULTI-ROTATION ENCODER

(71) Applicants: Jin Inoue, Chiyoda-ku (JP); Takeshi Musha, Chiyoda-ku (JP); Hiroshi Nishizawa, Chiyoda-ku (JP); Hajime Nakajima, Chiyoda-ku (JP); Ryosuke Takeuchi, Chiyoda-ku (JP); Tatsuya Ito, Chiyoda-ku (JP); Takashi Hirai, Chiyoda-ku (JP); Hiroshi Nagata, Chiyoda-ku (JP)

(72) Inventors: Jin Inoue, Chiyoda-ku (JP); Takeshi Musha, Chiyoda-ku (JP); Hiroshi Nishizawa, Chiyoda-ku (JP); Hajime Nakajima, Chiyoda-ku (JP); Ryosuke Takeuchi, Chiyoda-ku (JP); Tatsuya Ito, Chiyoda-ku (JP); Takashi Hirai, Chiyoda-ku (JP); Hiroshi Nagata, Chiyoda-ku (JP)

(73) Assignee: MITSUBISHI ELECTRIC CORPORATION, Chiyoda-ku, Tokyo (JP)

(21) Appl. No.: 14/380,289

(22) PCT Filed: Jan. 8, 2013
(86) PCT No.: PCT/JP13/50115

§ 371 Date: Aug. 21, 2014

(30) Foreign Application Priority Data
Apr. 17, 2012 (JP) 2012-094088
Sep. 11, 2012 (JP) 2012-199164

(51) Int. Cl. G01B 7/30; G01D 5/12

(52) U.S. Cl. CPC G01B 7/30; G01D 5/12
USPC 324/207.13

(57) ABSTRACT

A battery-less multi-rotation encoder including detection coils with the Barkhausen effect includes a rotation detection mechanism and a signal processing circuit. The detection coils generate voltage pulses with different positive and negative signs, and transmit them to the signal processing circuit, and the signal processing circuit includes a controller and an adder. The controller can set states of the detection coils to be High or Low and to maintain them at High or Low, based on the positive and negative signs of the respective voltage pulses and no voltage pulse being generated therefrom. The controller is configured to store the states of the respective detection coils in a memory. The adder can update a number of rotations according to the changes in the states of the respective detection coils. The signal processing circuit can determine the rotational angle of a rotational shaft within about 1/4 rotation unit.

### TECHNICAL FIELD

The present invention relates to multi-rotation encoders capable of detecting and then holding the direction of rotations of a rotating member in a motor and the like, and the number of rotations thereof, without being supplied with electric power from the outside.

### BACKGROUND ART

In general, a rotary encoder for detecting the rotational angle of a motor rotational shaft, for example, is constituted by a rotational disk which is coupled to the motor rotational shaft and is provided with optical or magnetic patterns thereon, and a detection device for reading the aforementioned optical or magnetic patterns. As rotary encoders of this type, there have been known those of increment types which are adapted to integrate pulse signals detected by the detection device for detecting the rotational angle of the rotational shaft. Further, there have been known those of absolute types which are adapted to detect an absolute angle of the rotational disk from a plurality of different patterns on the rotational disk.

As means for counting the number of rotations of the rotational shaft, when the number of rotations is equal to or more than one, there have been those which are adapted to utilize the encoders of the aforementioned absolute types connected through speed reduction gears. Further, there have been those which are adapted to count the cumulative value of the number of rotations using encoders of the aforementioned increment types and to electrically hold the cumulative value.

The latter encoders have the advantage of having simplified encoder structures, since they count and hold the number of rotations in electronic manners. However, the latter encoders are required to electrically hold the resultant number of rotations, even in the event of shutdowns of external power supplies. Therefore, they are required to incorporate backup batteries therein. Therefore, they have the problem of poor maintainability, since there is a need for replacement of the backup battery at regular time intervals.

On the other hand, the former types of encoders have the advantage of being capable of holding the number of rotations regardless of the presence or absence of an external power supply, since they count and hold the number of rotations in mechanical manners, but they involves complicated structures, thereby inducing the problems of cost increases and difficulty of improving the durability.

Therefore, in order to overcome these problems, there have been suggested battery-less multi-rotation encoders which employ no backup power supply, while being capable of electrically counting and holding the number of rotations.

As such a battery-less multi-rotation encoder, there has been suggested an encoder of a type which employs a magnetic wire having the large Barkhausen effect. The magnetic wire is constituted by a hard magnetic member in an inner side of the wire, and a soft magnetic member in an outer side of the wire. In the soft magnetic member, the relationship between an external magnetic field H and magnetization M is such that the magnetization M behaves in such a way as to abruptly reverse at a certain magnetic field (the large Barkhausen effect), as illustrated in FIG. 13. The velocity of this reversion is always constant, regardless of the way of the application of the external magnetic field H thereto. Therefore, with utilizing this, and by installing coils encompassing the magnetic wires as described above around a magnet which rotates together with a motor rotational shaft, it is possible to cause the coils to output voltage pulses which are always constant, regardless of the rotational speed of the motor.

FIG. 14 illustrates the number of rotations of the motor rotational shaft, the magnetic field applied to the magnetic wires from the magnet associated with the rotational shaft, and the voltage pulses outputted from the coils, in the aforementioned battery-less multi-rotation encoder. Referring to FIG. 14, it can be seen that, based on the rotational directions of the motor rotational shaft in CW (clockwise) and in CCW (counterclockwise), positive and negative voltage pulses are generated therefrom along with each constant rotation in the same rotational direction, although respective positions where the voltage pulses are generated are deviated from each other by an angle Φ. Accordingly, by utilizing the electric power of such voltage pulses, it is possible to count multi-rotations in a battery-less system.

For example, Patent Document 1 suggests a battery-less multi-rotation encoder which utilizes a battery-less system as described above and includes a magnet which is magnetized at two poles and is adapted to rotate together with a motor rotational shaft, two magnetic wires having the large Barkhausen effect which are placed above the magnet in such a way as to provide a phase angle of 90 degrees therebetween, wherein a signal processing circuit is driven by electric power of voltage pulses with a positive sign which are generated from respective coils wound on these two magnetic wires, and the number of rotations of the rotational shaft is detected through the aforementioned voltage pulses.

### PRIOR ART DOCUMENT

### Patent Document

Patent Document 1: JP 2008-014799 A

### SUMMARY OF THE INVENTION

### Problems to be Solved by the Invention

However, the apparatus in the aforementioned Patent Document 1 has problems as will be described below, with reference to FIG. 15 to FIG. 17.

FIG. 15 illustrates the relationship between the magnetic fields applied to the aforementioned two coils A and B, and the voltage pulses therefrom during rotations of the motor rotational shaft; and an A-phase output and a B-phase output, which are resulted from signal processing and indicate the states of the coils A and B. As illustrated in FIG. 15, the coils A and B output voltage pulses with different signs, namely positive and negative signs, with a phase difference of 90 degrees therebetween along with the reversions of the magnetic fields applied thereto. The signal processing circuit extracts only the voltage pulses with the positive sign and defines a state of the coil generating the voltage pulse as “High” and defines a state of the coil generating no voltage pulse as “Low”. FIG. 16(a) illustrates the A-phase output and the B-phase output, with respect to the rotation of the motor rotational shaft, in this case. As illustrated in FIG. 16(a), at first, a voltage pulse is generated, and when the A-phase is “High” and the B-phase is “low” at this time, the number of rotations is not changed. Next, a voltage pulse is generated and, when the A-phase is “Low” and the B-phase is “High”, the count of the number of rotations is increased by +1.

Next, there will be described cases where the rotation of the motor rotational shaft is reversed halfway therethrough. FIG. 17 illustrate the relationship between the magnetic fields applied to the aforementioned two coils A and B, and the voltage pulses therefrom; and the A-phase output and the B-phase output, in cases where the rotational direction of the motor rotational shaft is reversed from CW to CCW in the apparatus in Patent Document 1. FIG. 17(a) illustrates a case where the motor rotational shaft is reversed from the CW direction to the CCW direction after the motor rotational shaft has rotated by a rotational angle of 175+Φ/2 degrees. Further, FIG. 17(b) illustrates the A-phase output and the B-phase output, with respect to the number of rotations of the motor in this case. When the voltage pulse before the reversion is generated, the A-phase output is “Low”, and the B-phase output is “High”. When a voltage pulse is generated at first after the reversion, the A-phase output becomes “Low”, and the B-phase output becomes “High”.

As shown above, when the A-phase output state and the B-phase output state are the same as those of when the last voltage pulse was generated, it is determined that the rotational direction has been reversed. After the reversion, when the A-phase output and the B-phase output have gotten to become “Low” and “High”, respectively, the count of the number of rotations is decreased by 1.

Further, there will be described a case where the rotation of the motor rotational shaft is reversed at a different angle. FIG. 17(b) illustrates a case where the motor rotational shaft is reversed from the CW direction to the CCW direction, after the motor rotational shaft has rotated by a rotational angle of 175−Φ/2 degrees. Further, FIG. 16(c) illustrates the A-phase output and the B-phase output, with respect to the number of rotations of the motor in this case. In this case, the A-phase output and the B-phase output are changed from “Low” to “high” and “High” to “Low”, respectively, regardless of the reversion thereof from CW to CCW. This makes it impossible to detect the reversion of the motor rotation, thereby making it impossible to decrease the count of the number of rotations.

As described above, the apparatus in Patent Document 1 is adapted to cause repetitive changes from a state where the A-phase output is “High” and the B-phase output is “Low” to a state where the A-phase output is “Low” and the B-phase output is “High”, regardless of the rotational direction of the rotational shaft. This may make it impossible to detect signals at the time of reversions of the rotational direction of the rotational shaft, depending on the rotational angle of the motor rotational shaft, in some cases. Accordingly, the apparatus in Patent Document 1 has the problem of impossibility of detecting the number of rotations of the motor with accuracy.

Further, when a magnetic wire has been subjected to a magnetic field which slightly exceeds a threshold value and thus the magnetization of the wire has been reversed, a voltage pulse with reduced amplitude may be generated therefrom when the reversed magnetization is further reversed. If the amount of the reduction of the voltage pulse is larger, this may prevent the signal processing circuit from being driven, thereby inducing the problem of a dropout of detection of the voltage pulse.

The present invention is made in order to overcome the aforementioned problems and aims at providing a multi-rotation encoder capable of detecting the number of rotations of a rotational shaft with higher accuracy than those with conventional structures.

### Means for Solving the Problems

In order to attain the aforementioned object, there is provided a structure as follows, according to the present invention.

Namely, a battery-less multi-rotation encoder in one aspect of the present invention is adapted to detect and hold a rotational direction of a rotational shaft and a number of rotations of the rotational shaft without being supplied with electric power from outside, and the battery-less multi-rotation encoder comprises:

a rotational detection mechanism including a magnet configured to rotate together with the rotational shaft and have N magnetic poles in a circumferential direction of the rotational shaft, and L detection coils configured to have a magnetic wire with the Barkhausen effect with respect to a magnetic field from the magnet and be placed such that their phase angles are deviated from each other on a rotational circumference of the magnet, L being equal to or more than 2; and

a signal processing circuit electrically connected to the rotation detection mechanism,

the signal processing circuit including:

a non-volatile memory circuit adapted to hold a state of the respective detection coils and the number of rotations of the rotational shaft; and

a circuit configured to determine a current state, the rotational direction of the rotational shaft and the number of rotations of the rotational shaft based on four factors which are presence or absence of voltage pulses from the respective detection coils, and positive and negative signs of the voltage pulse waveforms, and based on the state and the number of rotations which have been held in the non-volatile memory circuit and, further, configured to write the new state of the respective coils and the new number of rotations into the non-volatile memory circuit; and

the signal processing circuit further including a voltage circuit configured to generate a voltage for driving the signal processing circuit with the voltage pulses generated from the respective detection coils, and

the signal processing circuit being adapted to determine a rotational angle of the rotational shaft within 1/(LN) rotation unit.

### Effects of the Invention

With the battery-less multi-rotation encoder in one aspect of the present invention, the controller in the signal processing circuit is adapted to set states of the respective detection coils and store the states in the memory, wherein the states are set, using both the positive and negative voltage pulses which are outputted from the L detection coils and based on no voltage pulse being generated therefrom, to be High or Low and further to maintain High or Low when no voltage pulse is being generated therefrom. Further, the number of rotations is detected based on this stored state, which enables counting the number of rotations without losing count thereof, even when the rotational shaft is reversely rotated halfway through rotations. Therefore, assuming that the number of magnetic poles is N in the magnet included in the rotation detection mechanism, it is possible to detect the rotational angle of the rotational shaft within about 1/(LN) rotation, which enables detecting the number of rotations of the rotational shaft with higher accuracy than those with conventional structures.

### BRIEF DESCRIPTION OF THE DRAWINGS

FIG. 1 is a view illustrating the structure of a battery-less multi-rotation encoder according to a first embodiment of the present invention.

FIG. 2 is an explanation view illustrating the placement of respective detection coils included in the battery-less multi-rotation encoder illustrated in FIG. 1.

FIG. 3 is an explanation view illustrating the relationship between the voltage pulses generated from the respective detection coils and the magnetic fields exerted on the magnetic wires in the respective detection coils included in the battery-less multi-rotation encoder illustrated in FIG. 1, and the states of the respective detection coils.

FIG. 4 is an explanation view illustrating the states of the respective detection coils with respect to the rotation of the rotational shaft in the battery-less multi-rotation encoder illustrated in FIG. 1.

FIG. 5 is an explanation view illustrating hysteresis in the voltage pulses outputted from the respective detection coils, and the magnetic fields applied on the magnetic wires in the respective detection coils included in the battery-less multi-rotation encoder illustrated in FIG. 1.

FIG. 6 is an explanation view illustrating the states of the respective detection coils, when the rotational direction of the rotational shaft is reversed, in the battery-less multi-rotation encoder illustrated in FIG. 1.

FIG. 7 is a view illustrating a signal processing table for determining the states of the respective detection coils and the number of rotations in the battery-less multi-rotation encoder illustrated in FIG. 1.

FIG. 8 is a view illustrating the structure of a signal processing IC in a battery-less multi-rotation encoder according to a second embodiment of the present invention.

FIG. 9 is a view illustrating the structure of a signal processing IC in a battery-less multi-rotation encoder according to a third embodiment of the present invention.

FIG. 10 is a view illustrating the placement of respective detection coils in a battery-less multi-rotation encoder according to a fourth embodiment of the present invention.

FIG. 11 is a view illustrating a signal processing table for determining the states of the detection coils and the number of rotations in the battery-less multi-rotation encoder according to the fourth embodiment of the present invention.

FIG. 12 is a view illustrating the structure of a multi-rotation encoder according to a fifth embodiment of the present invention.

FIG. 13 is a curve of a magnetic field “H” with respect to magnetization “M” in a magnetic wire, illustrating the Barkhausen jump therein.

FIG. 14 is a view illustrating the relationship between voltage pulses generated from detection coils and the magnetic fields applied on the magnetic wires.

FIG. 15 is an explanation view illustrating the relationship between voltage pulses generated from respective detection coils and the magnetic fields exerted on the magnetic wires, and the states of the respective detection coils, in a conventional battery-less multi-rotation encoder.

FIG. 16 is an explanation view illustrating the states of the respective detection coils with respect to the rotation of a rotational shaft, in the conventional battery-less multi-rotation encoder.

FIG. 17 is an explanation view illustrating the relationship between the voltage pulses generated from the respective detection coils and the magnetic fields exerted on the magnetic wires, and the states of the respective detection coils, when the rotational direction of the rotational shaft is reversed, in the conventional battery-less multi-rotation encoder.

### EMBODIMENTS OF THE INVENTION

Hereinafter, battery-less multi-rotation encoders according to embodiments of the present technique will be described, with reference to the drawings. Further, throughout the drawings, the same or similar structural portions are designated by the same reference characters. Further, matters which have been already well known may not be described in detail, and structures which are substantially the same may not be described redundantly, in some cases, in order to prevent the following descriptions from being unnecessarily redundant, for allowing those skilled in the art to easily understand them.

### First Embodiment

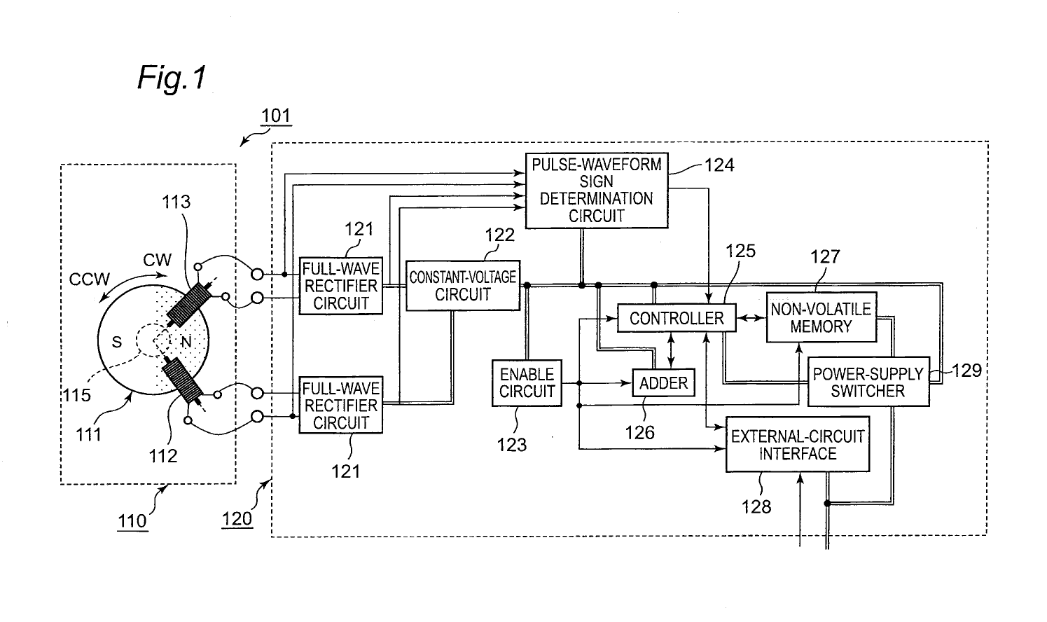

FIG. 1 illustrates the structure of a battery-less multi-rotation encoder 101 according to a first embodiment of the present invention. The battery-less multi-rotation encoder 101 according to the present embodiment is a multi-rotation encoder adapted to detect and hold the rotational direction and the number of rotations of a rotational shaft, without being supplied with electric power from the outside. The battery-less multi-rotation encoder 101 generally includes a rotation detection mechanism 110 and a signal processing circuit 120 which is electrically connected to the rotation detection mechanism 110.

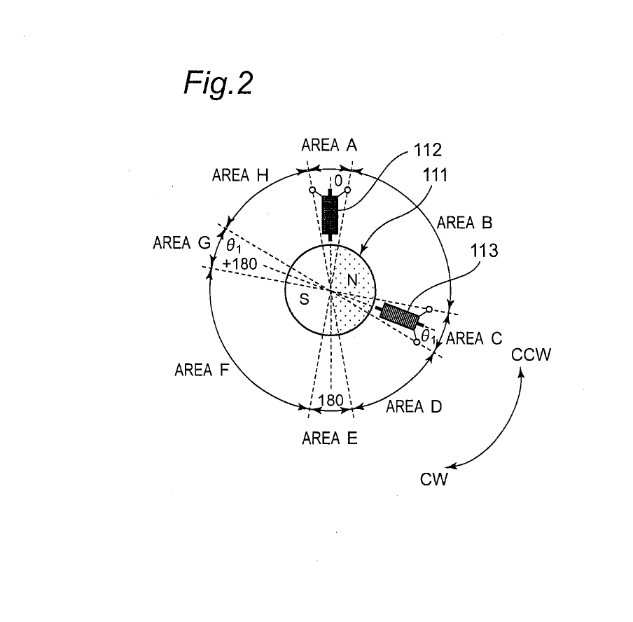

As illustrated in FIG. 2, the rotation detection mechanism 110 is a mechanism which includes a magnet 111, and detection coils 112 and 113 and is adapted to detect rotations of a rotational shaft 115. Further, the rotational shaft 115 corresponds to the output shaft (the rotational shaft) of a motor and the like, for example, but is not limited thereto and corresponds to any rotating member rotatable in the direction about an axis.

The magnet 111 has a disk shape and is mounted concentrically with the rotational shaft 115 and is adapted to rotate CW (clockwise) and CCW (counterclockwise) together with the rotational shaft 115. The rotational shaft 115 and the magnet 111 are placed concentrically with each other as described above in the present embodiment, but they are required to be structured only such that the magnet 111 rotates in conjunction with the rotation of the rotational shaft 115. Further, the magnet 111 has two magnetic poles each corresponding to a half of the circumference in the present embodiment, but it also can have three or more magnetic poles.

The detection coils 112 and 113 are placed above a rotational circumference of the magnet 111 above the magnet 111 and are formed from magnetic wires having the large Barkhausen effect. In the present embodiment, there are provided the two detection coils 112 and 113, but it is also possible to provide three or more detection coils.

Hereinafter, there will be described the positional relationship between the detection coils 112 and 113 and the magnet 111 which is magnetized to have two poles, and the logic for detecting the number of rotations of the rotational shaft 115.

At first, there will be described the positional relationship between the detection coils 112 and 113. The magnetic wires having the large Barkhausen effect induce hysteresis corresponding to the number of rotations Φ, as described with reference to FIG. 14. Therefore, in order to prevent the outputs from the detection coils 112 and 113 from overlapping with each other, regardless of the rotational direction of the rotational shaft 115, the detection coil 113 is arranged with respect to the detection coil 112 such that the phase angle therebetween is larger than Φ but smaller than 180−Φ.

Generally, assuming that the number of magnetic poles in the magnet 111 is N, based on the hysteresis angle Φ, one or more second detection coils (for example, the detection coil 113) are placed with respect to a single first detection coil (for example, the detection coil 112) such that the phase angle between the first detection coil and the second detection coils falls within an angle range which is larger than the hysteresis angle Φ but is smaller than (360/N)−Φ.

Further, hereinafter, for simplification of the description, the description will be given, assuming that the aforementioned phase angle is 90 degrees.

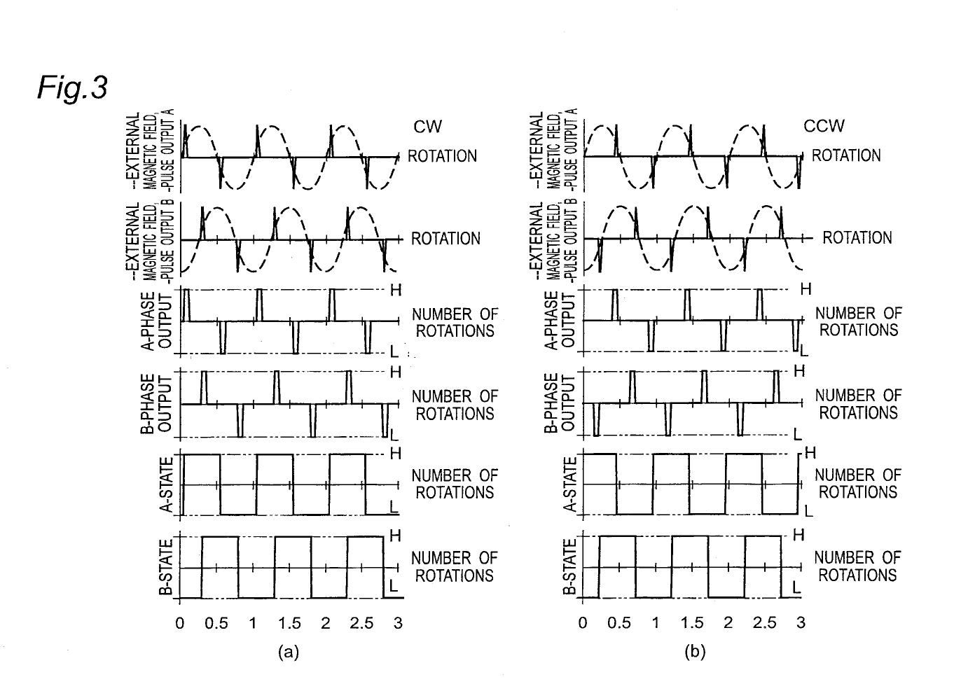

FIG. 3 illustrates relationship between the magnetic fields applied on the detection coils 112 and 113 from the magnet 111 and voltage pulses generated from the detection coils 112 and 113, an A-phase output to which an output of the detection coil 112 is digitalized, a B-phase output to which an output of the detection coil 113 is digitalized, an A-state of the detection coil 112, and a B-state of the detection coil 113. FIG. 3(a) is a view of a case where the rotational direction of is the CW direction. FIG. 3(b) is a view of a case where the rotational direction is the CCW direction.

The A-phase output and the B-phase output are outputted to be “High” when the outputs from the detection coils 112 and 113 are voltage pulses with the positive sign, respectively, and the A-phase output and the B-phase output are outputted to be “Low” when the outputs from the detection coils 112 and 113 are voltage pulses with the negative pulse, respectively. Further, the A-phase output and the B-phase output are outputted to be null (zero) when no voltage pulse is generated from the detection coils 112 and 113, respectively.

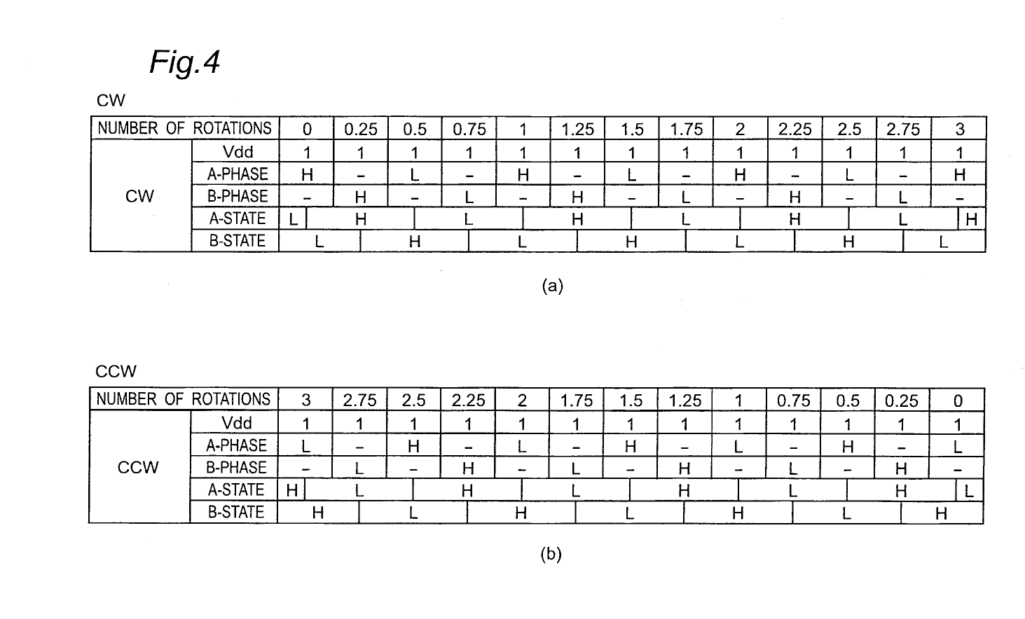

Regarding the A-state and the B-state, the A-state and the B-state are “High”, when the A-phase output and the B-phase output are High, respectively, and the A-state and the B-state are “Low”, when the A-phase output and the B-phase output are Low, respectively. Further, when the A-phase output and the B-phase output are null (zero), the states of the A-state and the B-state are not changed, respectively. FIGS. 4(a) and 4(b) illustrate the transitions of the A-state and the B-state with respect to the number of rotations. FIG. 4(a) illustrates a case where the rotational direction of the rotational shaft 115 is CW, and FIG. 4(b) illustrates a case where the rotational direction thereof is CCW. It can be seen that, from the respective High/Low states of the A-state and the B-state, the rotational angle of the rotational shaft 115 can be identified within the range from 90 degrees or Φ degrees to 180−Φ degrees. Therefore, when the A-state is changed from Low to High, and the B-state is low and is not changed, the count is increased by +1. Further, when the A-state is changed from High to Low, and the B-state is low and is not changed, the count is decreased by −1. Thus, it is possible to detect the number of rotations, regardless of the rotational direction.

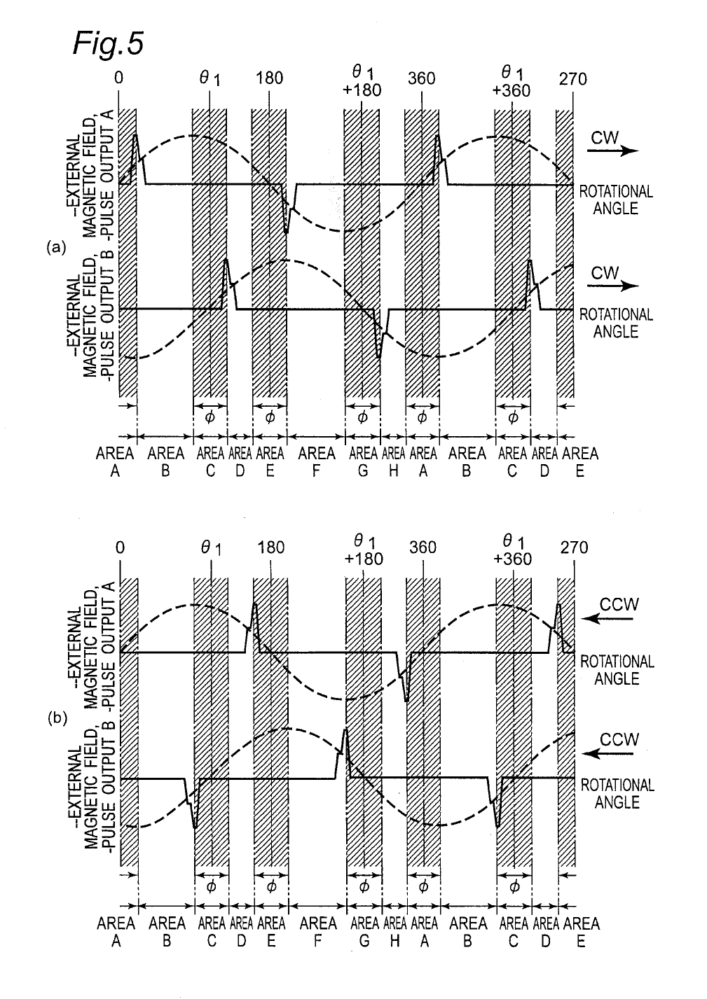

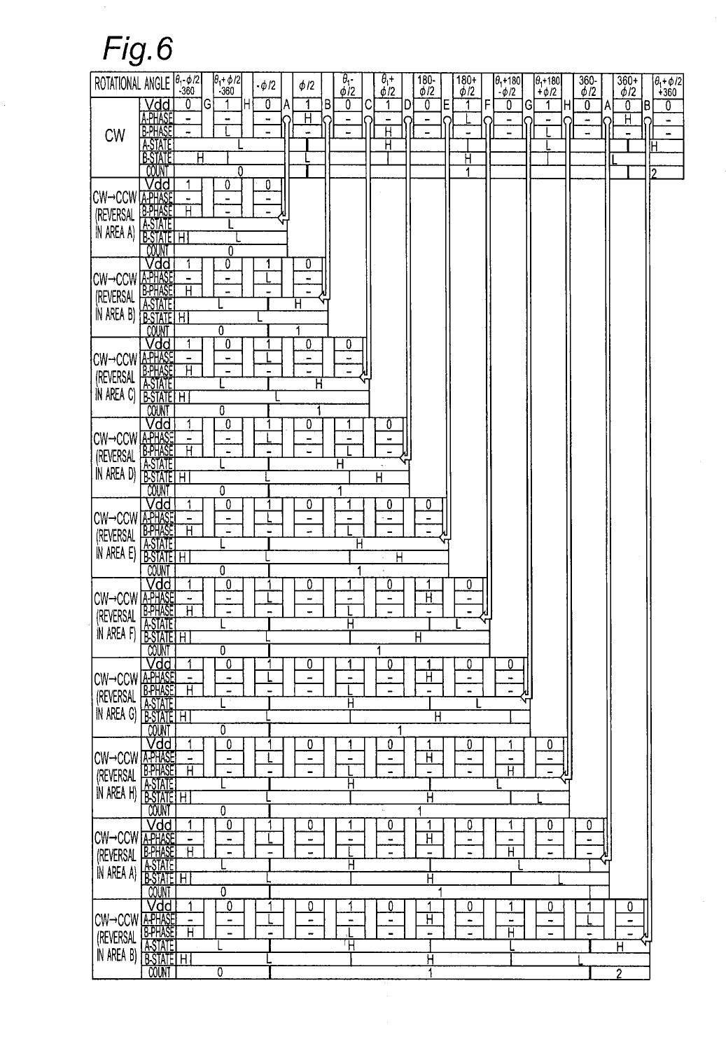

Next, FIG. 6 illustrates the A-state, the B-state, and the count value with respect to the rotational angle in cases where the rotational direction of the rotational shaft 115 is reversed halfway therethrough. According to the respective voltage pulses generated from the detection coils 112 and 113 along with the rotation of the rotational shaft 115, the single-rotation range can be divided into areas such that it is sorted into 8 areas, which are areas A to H as illustrated in FIG. 5(a) and FIG. 5(b) (FIG. 5(a) illustrates a case where it is rotated in the CW direction, and FIG. 5(b) illustrates a case where it is rotated in the CCW direction). Therefore, in FIG. 6, there are illustrated all the cases where the rotational direction thereof is reversed from CW to CCW in the respective areas. Referring to the item of “the count value” in FIG. 6, it can be seen that no deviation is induced in the count value, no matter in which area the rotational shaft 115 is reversed.

Further, three or more detection coils can be provided or the number of magnetizations in the magnet 111 can be made three or more and, thus, the resolution within the single-rotation range can be made smaller than the range from 90 degrees or Φ degrees to 180−Φ degrees, which induces no problem.

Next, there will be described operations of the signal processing IC (which is the same as the aforementioned signal processing circuit) 120 when respective voltage pulses are generated from the detection coils 112 and 113.

As illustrated in FIG. 1 in the present embodiment, the signal processing IC 120 includes full-wave rectifier circuits 121, a constant-voltage circuit 122, an Enable circuit 123, a pulse-waveform sign determination circuit 124, a controller 125, an adder 126, a non-volatile memory 127, an external-circuit interface 128, and a power-supply switcher 129. The controller 125 and the adder 126 correspond to basic structural components in the signal processing IC 120.

In this structure, the respective voltage pulses generated from the detection coils 112 and 113 are rectified by the respective full-wave rectifier circuits 121, 121 and, thereafter, are made to be constant voltages by the constant-voltage circuit 122. The constant voltages are supplied as electric power to the Enable circuit 123, the pulse-waveform sign determination circuit 124, the controller 125, the adder 126 and the non-volatile memory 127. Further, the power-supply switcher 129 has the function of outputting electric power supplied from the constant-voltage circuit 122 and electric power supplied from the outside in such a way as to change over therebetween. Thus, a constant voltage is supplied to the controller 125 and the non-volatile memory 127 through the power-supply switcher 129. Further, the external power supply is a main power supply and does not correspond to a backup power supply and, therefore, the provision of the power-supply switcher 129 is not inconsistent to the structure of the buttery-less multi-rotation encoder.

Next, the Enable circuit 123 recognizes that the voltages from the constant-voltage circuit 122 have been sufficiently stabilized. Thereafter, the Enable circuit 123 transmits an operation-starting trigger to the pulse-waveform sign determination circuit 124, the controller 125, the adder 126 and the non-volatile memory 127.

On receiving the operation-starting trigger, the pulse-waveform sign determination circuit 124 determines the A-phase output and the B-phase output from the respective voltage pulses from the detection coils 112 and 113 and, further, transmits them to the controller 125.

The controller 125 reads, from the non-volatile memory 127, the number of rotations of the rotational shaft 115 and the A-state and the B-state of when the last voltage pulse was generated. Further, the controller 125 transmits them to the adder 126.

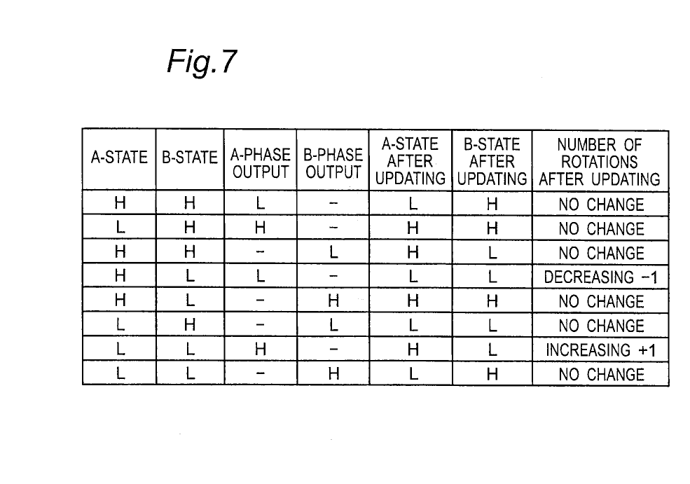

The adder 126 updates the A-state, the B-state and the number of rotations using a conversion table in FIG. 7 based on the received information (the number of rotations, the A-phase output and the B-phase output, and the A-state and the B-state). Further, the adder 126 transmits the newest A-state, the newest B-state and the newest number of rotations to the controller 125.

The controller 125 accesses the non-volatile memory 127 again with the information from the adder 126 and, writes this information therein.

The signal processing IC 120 performs these series of operations, only with the electric power generated from the respective voltage pulses from the detection coils 112 and 113, through the full-wave rectifier circuits 121 and the constant-voltage circuit 122. Furthermore, the signal processing IC 120 completes the operations before the generation of the next voltage pulse.

When the number of rotations of the rotational shaft 115 is read from the outside of the buttery-less multi-rotation encoder 101, the non-volatile memory 127 is accessed through the external circuit interface 128 and the controller 125 in the mentioned order and, thus, the number of rotations is read therefrom. At this time, in order to prevent the series of operations for detecting the number of rotations and the operations for reading it from the outside from coinciding each other, the controller 125 restricts the access to the non-volatile memory 127 from the outside. Further, when it is accessed from the outside, the controller 125 and the non-volatile memory 127 are supplied with electric power from the outside through the power-supply switcher 129, while the external circuit interface 128 is directly supplied with electric power from the outside. This enables reading the number of rotations from the non-volatile memory 127, regardless of the electric power from the voltage pulses from the detection coils 112 and 113.

As described above, in the battery-less multi-rotation encoder 101, the states of the detection coils 112 and 113 as the A-state and the B-state are held in the non-volatile memory 127 by using both the positive and negative signs of the voltage pulses generated from the two detection coils 112 and 113. This enables detecting the number of rotations without losing count thereof even when the rotational shaft 115 is reversely rotated halfway therethrough. Furthermore, the aforementioned operations can be executed only with the electric power of the voltage pulses from the detection coils 112 and 113.

Further, in assembling the battery-less multi-rotation encoder 101 or in re-assembling it after disassembling it once, the actual positional relationship between the magnet 111 and the detection coils 112 and 113 is not necessarily coincident with the positional relationship between the magnet 111 and the detection coils 112 and 113 which is estimated from the state A and the state B of when the last voltage pulse was generated, which are in the non-volatile memory 127. Therefore, in an initial setting mode, the controller 125 and the adder 126 perform operations for continuously updating the state A and the state B in the non-volatile memory 127 without updating the number of rotations, until the generation of voltage pulses at least twice such that the actual positional relationship between the magnet 111 and the detection coils 112 and 113 is reflected by the state A and the state B of when the last voltage pulse was generated, which are in the non-volatile memory 127.

### Second Embodiment

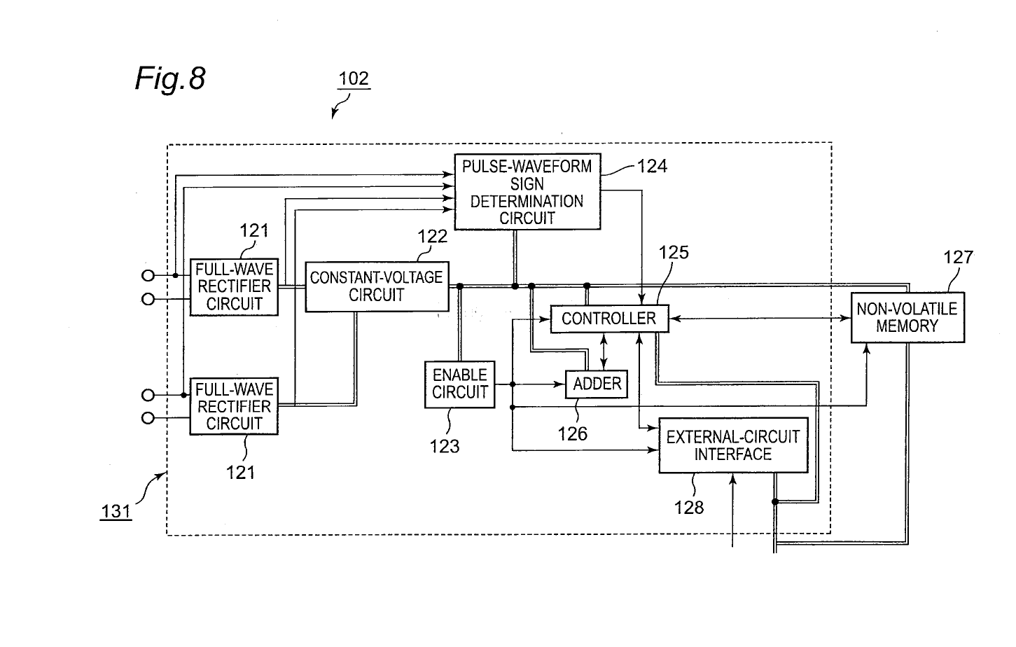

With reference to FIG. 8, there will be described a battery-less multi-rotation encoder 102 according to a second embodiment of the present invention.

The battery-less multi-rotation encoder 102 according to the present embodiment also includes the rotation detection mechanism 110, and a signal processing circuit which is electrically connected to the rotation detection mechanism 110, similarly to the aforementioned battery-less multi-rotation encoder 101. The battery-less multi-rotation encoder 102 according to the present embodiment is different from the aforementioned battery-less multi-rotation encoder 101 in that it includes a signal processing circuit 131 instead of the signal processing circuit 120. Further, the signal processing circuit 131 is different from the signal processing circuit 120 in that the non-volatile memory 127 is placed outside the signal processing circuit. The other structures in the signal processing circuit 131 are the same as those in the signal processing circuit 120.

With this structure, with the battery-less multi-rotation encoder 102, it is possible to provide the same effects as those provided by the battery-less multi-rotation encoder 101 and, further, it is possible to eliminate the necessity of manufacturing processes for the non-volatile memory 127 in fabricating the signal processing IC. Accordingly, with the battery-less multi-rotation encoder 102, it is possible to decrease the cost of the signal processing IC and to increase the manufacturers thereof in comparison with the case of the battery-less multi-rotation encoder 101. Further, it is possible to employ a general-purpose product as the non-volatile memory 127, which enables improvement in availability and costs.

### Third Embodiment

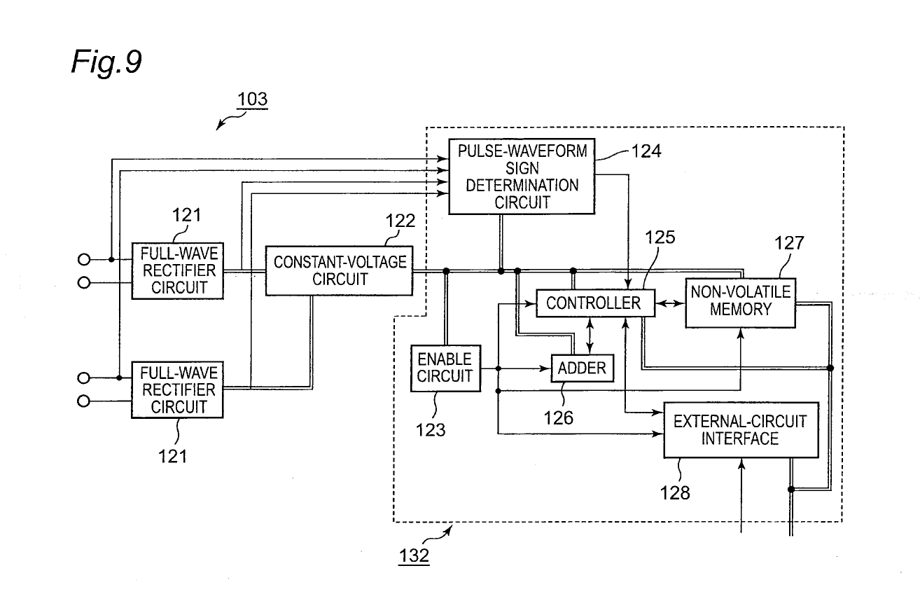

With reference to FIG. 9, there will be described a battery-less multi-rotation encoder 103 according to a third embodiment of the present invention.

The battery-less multi-rotation encoder 103 according to the present embodiment also includes the rotation detection mechanism 110, and a signal processing circuit which is electrically connected to the rotation detection mechanism 110, similarly to the aforementioned battery-less multi-rotation encoder 101. The battery-less multi-rotation encoder 103 according to the present embodiment is different from the aforementioned battery-less multi-rotation encoder 101 in that it includes a signal processing circuit 132 instead of the signal processing circuit 120. Further, the signal processing circuit 132 is different from the signal processing circuit 120 in that full-wave rectifier circuits 121 and the constant-voltage circuit 122 are placed between the rotation detection mechanism 110 and the signal processing circuit 132, outside the signal processing circuit. The other structures in the signal processing circuit 132 are the same as those in the signal processing circuit 120.

With this structure, with the battery-less multi-rotation encoder 103, it is possible to provide the same effects as those provided by the battery-less multi-rotation encoder 101 and, further, it is possible to restrict the values of voltages inputted to the signal processing circuit 132. Accordingly, with the battery-less multi-rotation encoder 103, it is possible to decrease the withstand input voltage of the signal processing circuit 132, thereby reducing the cost, in comparison with the case of the battery-less multi-rotation encoder 101.

### Fourth Embodiment

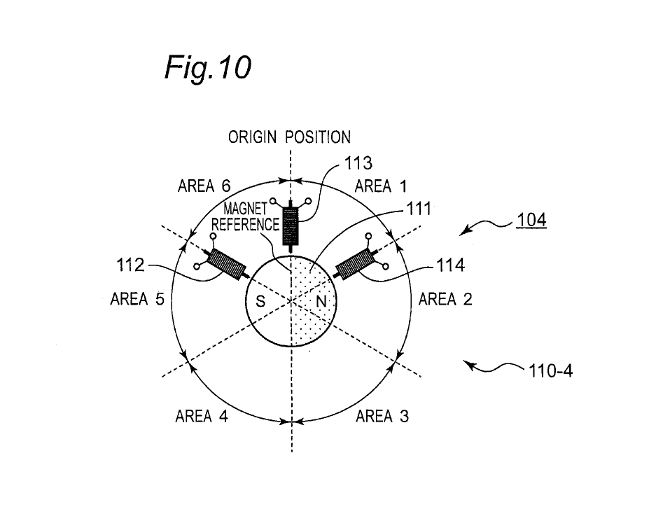

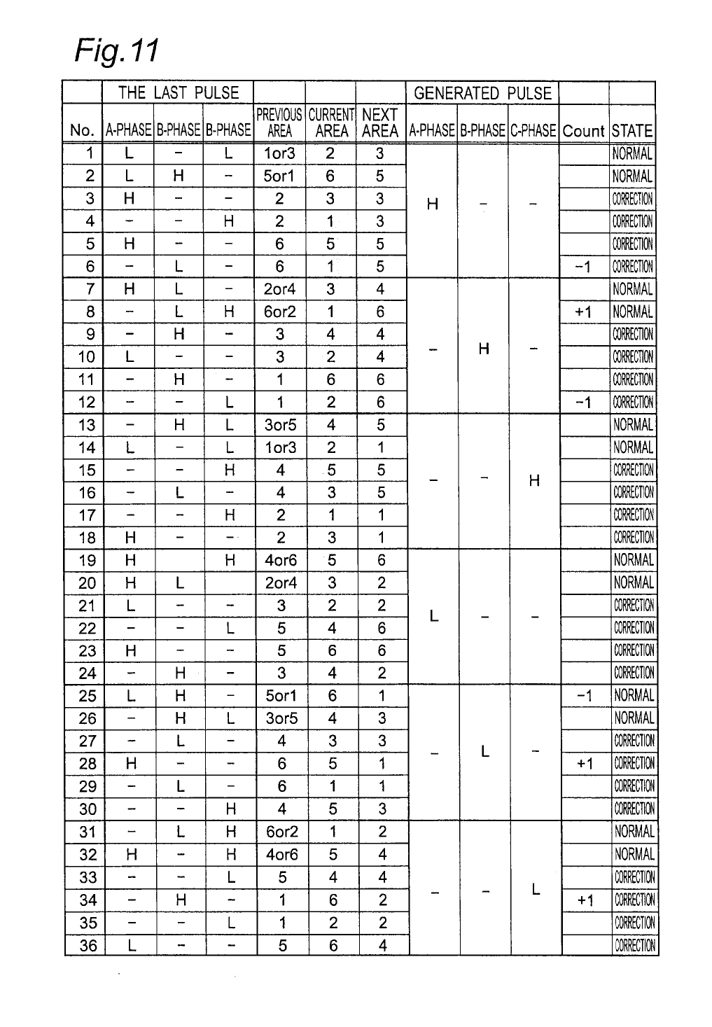

With reference to FIGS. 10 and 11, there will be described a battery-less multi-rotation encoder 104 according to a fourth embodiment of the present invention.

The battery-less multi-rotation encoder 104 according to the present embodiment also includes a rotation detection mechanism, and the signal processing circuit 120 which is electrically connected to the rotation detection mechanism, similarly to the aforementioned battery-less multi-rotation encoder 101. The battery-less multi-rotation encoder 104 according to the present embodiment is different from the aforementioned battery-less multi-rotation encoder 101 in that it includes a rotation detection mechanism 110-4 instead of the rotation detection mechanism 110. FIG. 10 illustrates the structure of the rotation detection mechanism 110-4.

In the battery-less multi-rotation encoder 104 according to the present embodiment, three or more detection coils 112, 113 and 114 are placed above the rotational circumference of the magnet 111 such that their phase angles are deviated from each other, and the non-volatile memory 127 in the signal processing circuit 120 is adapted to hold the last state and the last but one state of the aforementioned detection coils, the states having been set along with rotations of the magnet 111. Further, when any of the aforementioned detection coils has generated a voltage pulse, the signal processing circuit 120 compares it with the coil state having been set based on the last generated voltage pulse. If the aforementioned generated voltage pulse is different from a voltage pulse estimated to be resulted from the movement of the magnet 111 from the rotational position thereof, which is identified from the last coil state, the signal processing circuit 120 corrects the value of the number of rotations of the rotational shaft or generates an error output, based on the last pulse state and the last but one pulse state, and based on the aforementioned generated voltage pulse.

With the battery-less multi-rotation encoder 104 having this structure, it is possible to identify the corrected position in the event of a dropout of pulse detection, using the three or more detection coils and information about the last but one state of the detection coils. This enables counting the number of rotations without losing count thereof even when the rotational shaft is reversely rotated halfway through rotations. Further, this enables detecting the number of rotations with higher reliability in such a way as to permit a single pulse dropout.

Next, there will be described, in more detail, the structure and operations of the battery-less multi-rotation encoder 104 according to the present embodiment.

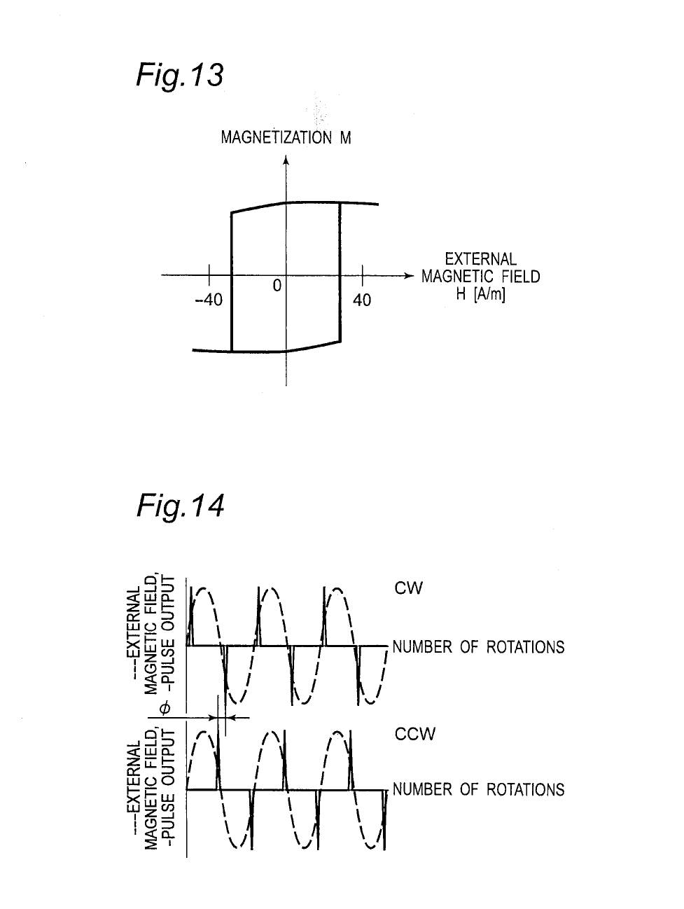

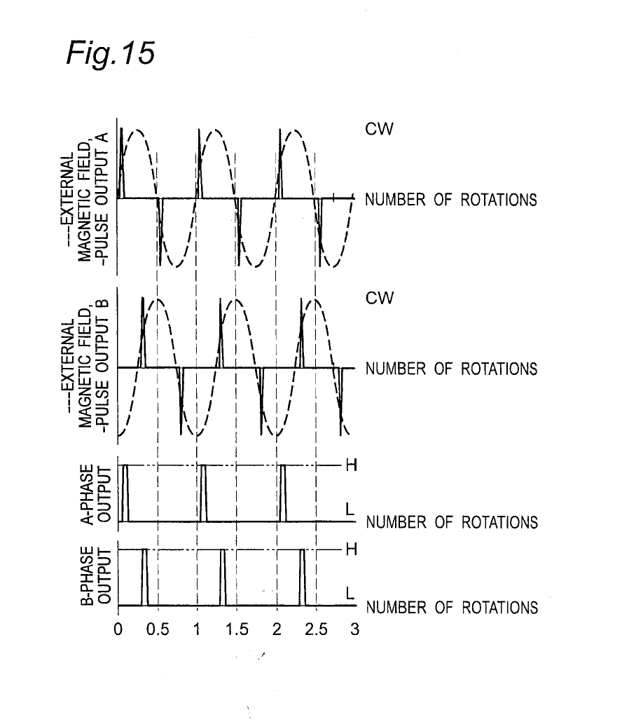

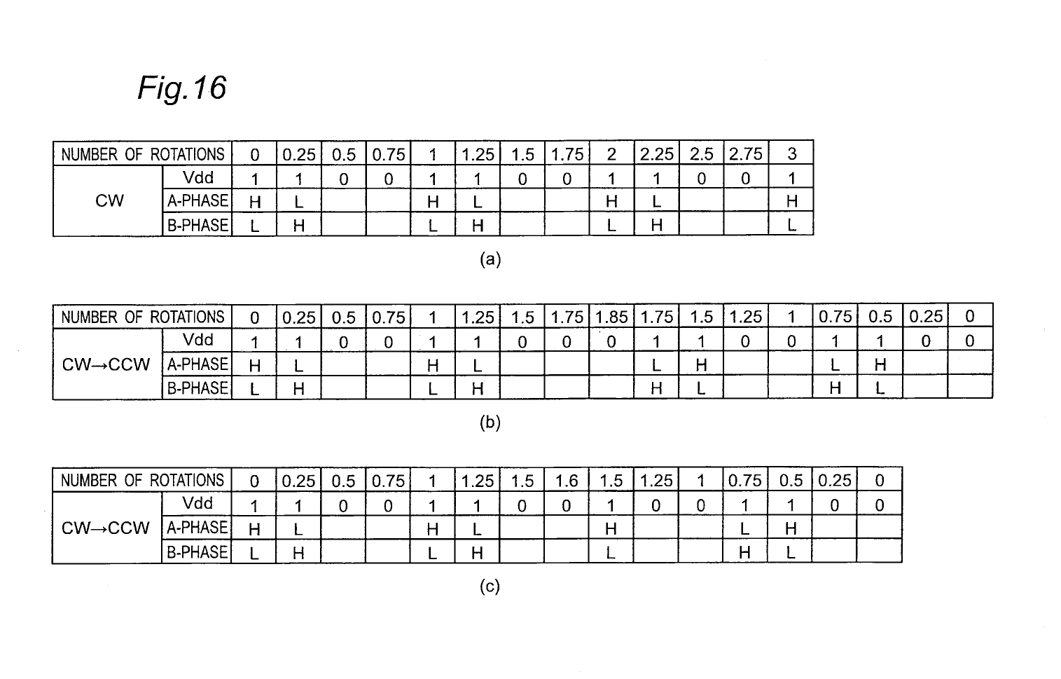

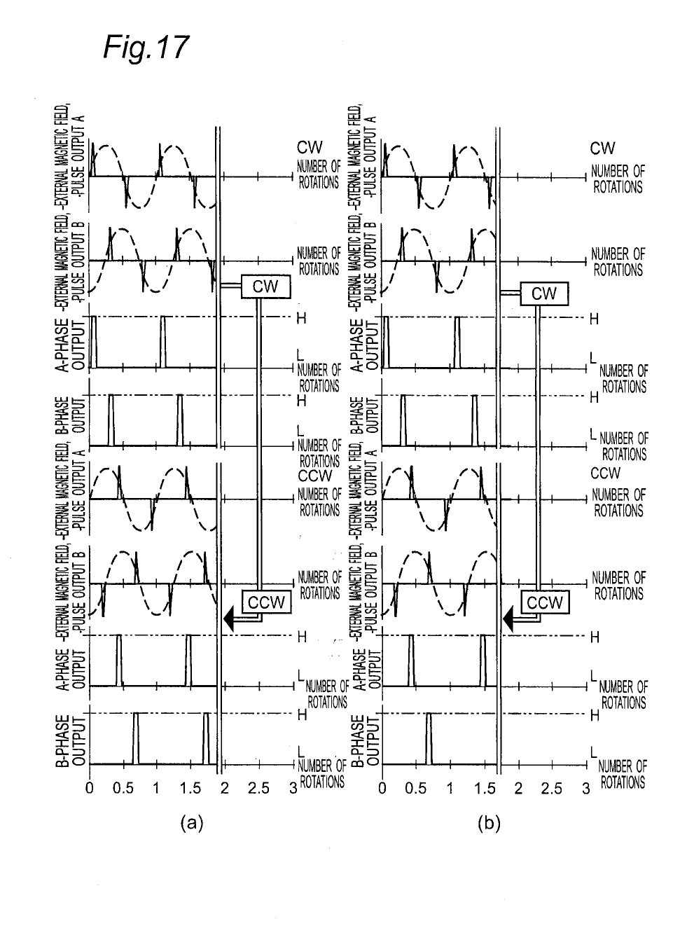

The magnetic wire having the Barkhausen effect is caused to abruptly reverse its magnetization when being subjected to a certain magnetic field and, thus, the coil generates a constant voltage pulse, as previously described with reference to FIG. 13. However, there is a phenomenon as follows. That is, if the magnetic field applied thereto is not sufficiently larger than a threshold value for the magnetization reversion, namely in a case that the applied magnetic field slightly exceeds the threshold value to generate a voltage pulse and, immediately thereafter, the rotation of the magnet 111 is reversed, even when the applied magnetic field exceeds the threshold value in the opposite direction of magnetic-field application from that of the applied magnetic field which generated the aforementioned voltage pulse along with the rotation of the magnet 111, an intensity of a voltage pulse is decreased. If the reduction of the generated voltage pulse is significant, this prevents the signal processing circuit 120 from operating, which induces a phenomenon in which the actual position of the rotating magnet 111 is different from the estimated position of the magnet 111 which is identified from the state having been held based on the detected voltage pulse.

Therefore, in the rotation detection mechanism 110-4 in the battery-less multi-rotation encoder 104 according to the present embodiment, as illustrated in FIG. 10, there are placed the three detection coils, which are the A-phase detection coil 112, the B-phase detection coil 113, and the C-phase detection coil 114, at positions deviated by predetermined phases with respect to the magnet 111. In the present embodiment, the placement of the respective detection coils is such that the detection coils 112 and 114 are arranged at respective positions of 60 degrees, in a central angle of the magnet 111, toward the CW direction and the CCW direction with respect to the detection coil 113. However, the positions of the respective detection coils are not limited thereto. Further, the number of the detection coils can be any number equal to or more than 3.

Further, the respective detection coils 112, 113 and 114 divide an area into six angular areas with respect to “an origin position”, and these respective angular areas are defined as “area 1” to “area 6” in the CW direction from the origin position. Further, the angular position in the rotating magnet 111 across which there is an S-to-N change in the CW direction is defined as “a magnet reference”.

It is assumed that, in a condition where the B-phase detection coil 113 is placed at the origin position and the magnet reference exists at the origin position, the magnet reference is moved in the CW direction from the area 6 to the area 1, which causes the magnetization-reversion threshold value to be exceeded in the B-phase detection coil 113. Thus, the B-phase detection coil 113 generates a voltage pulse. In this situation, if the rotation of the magnet 111 is reversed from the position where the above voltage pulse was generated and the magnet reference is returned to the area 6 from the area 1, the signal processing circuit 120 in the battery-less multi-rotation encoder 104 performs operations as follows. Namely, as described above, since the magnet 111 is rotated in the CCW direction, a magnetic field exceeding the threshold value from the magnet 111 acts on the B-phase detection coil 113 in the opposite magnetic-field direction. However, the B-phase detection coil 113 generates a smaller voltage pulse, which prevents the signal processing circuit 120 from operating. Therefore, the signal processing circuit 120 maintains the state of the B-phase detection coil 113 which indicates that the position of the magnetic reference in the magnet 111 is in the area 1. Further, if the magnet 111 proceeds in the CCW direction, the A-phase detection coil 112 generates a voltage pulse, since the magnetic field from the magnet 111 exceeds the threshold value of the A-phase detection coil 112. However, since the signal processing circuit 120 has held the fact that the position of the magnet reference is in the area 1, only the B-phase detection coil 113 or the C-phase detection coil 114 can generate a voltage pulse due to the movement from the area 1 to area 6 or the area 2. This enables detecting the occurrence of an erroneous operation in the signal processing circuit 120. Further, the aforementioned operations will be referred to as “former case”, for giving the following description.

The aforementioned situation where the A-phase detection coil 112 generates a voltage pulse with the state of the area 1 being held can also occur in the following case. Namely, the magnet reference moves in the CCW direction from the area 2 to the area 1, thereafter, the rotation thereof is reversed to cause the magnet reference to shift from the area 1 to the area 2 while inducing a dropout of the voltage pulse and, further, it is rotated in the CW direction to move the magnet reference to the area 3. In this case, similarly to in the former case, there can be no movement from the area 1 to another area which causes the A-phase detection coil 112 to generate a voltage pulse. This enables detecting the occurrence of an erroneous operation. Further, the aforementioned operations will be referred to as “latter case”, for giving the following description.

In any of the former and latter cases, the position of the magnet reference in the magnet 111 which is identified based on the last state of the detection coils is in the same area, which is the area 1. This enables detection of erroneous operations, but does not enable corrections. On the other hand, the position of the magnet reference in the magnet 111 which is identified based on the last but one state of the detection coils and held by the signal processing circuit 120 is in the area 6 in the former case and is in the area 2 in the latter case, which are different from each other and can be distinguished from each other. In the former example, it is possible to determine that a dropout of the voltage pulse generated by the movement from the area 1 to the area 6 was induced, and the A-phase detection coil generated a voltage pulse due to the movement from the area 6 to the area 5. Thus, this enables correcting the state held by the signal processing circuit 120 from the area 1 to the area 5 by skipping a single area and, also, enables correcting the count value of the number of rotations by −1. Further, in the latter case, similarly, it is possible to perform the same corrections. As described above, based on the last pulse state and the last but one pulse state, and based on the generated voltage pulses, it is possible to correct the state of holding the pulse states, and the value of the number of rotations of the rotational shaft.

Further, the signal processing circuit 120 holds the state of the detected pulses in the non-volatile memory 127 in the signal processing circuit 120, as described above. FIG. 11 illustrates a table representing state transitions as described above. In FIG. 11, the aforementioned states coincide with No. 6 (corresponding to the aforementioned the “former case”) and No. 4 (corresponding to the aforementioned the “latter case”). The current area is determined from the last state of the detection coils, and the previous area is determined from the last but one state of the detection coils. If a state transition which is not represented in the aforementioned state transition table in FIG. 11 is induced, this indicates the occurrence of a phenomenon different from expected pulse dropouts, and then the signal processing circuit 120 generates an error output.

Further, the previous area can be uniquely determined, by obtaining information about whether it has shifted from the previous area to the current area in the CW direction or the CCW direction. Therefore, it is also possible to reduce the amount of information to be stored, by using this information about the direction of shift.

Further, the description of “or” in the item of “the previous area” in the table of FIG. 11 indicates that the shift to the next area is the same, no matter which of the areas adjacent to the current area is the previous area, provided that the area determination is correctly performed. For example, in the case of No. 1, no matter which area of “1 or 3” is the previous area, the next area is the same area, which is “3”.

Further, it is possible to apply the structures described in the second or third embodiment to the battery-less multi-rotation encoder 104 according to the fourth embodiment.

Further, it is also possible to employ structures provided by properly combining the aforementioned respective embodiments. With such structures, it is possible to provide the respective effects provided by the combined embodiments.

### Fifth Embodiment

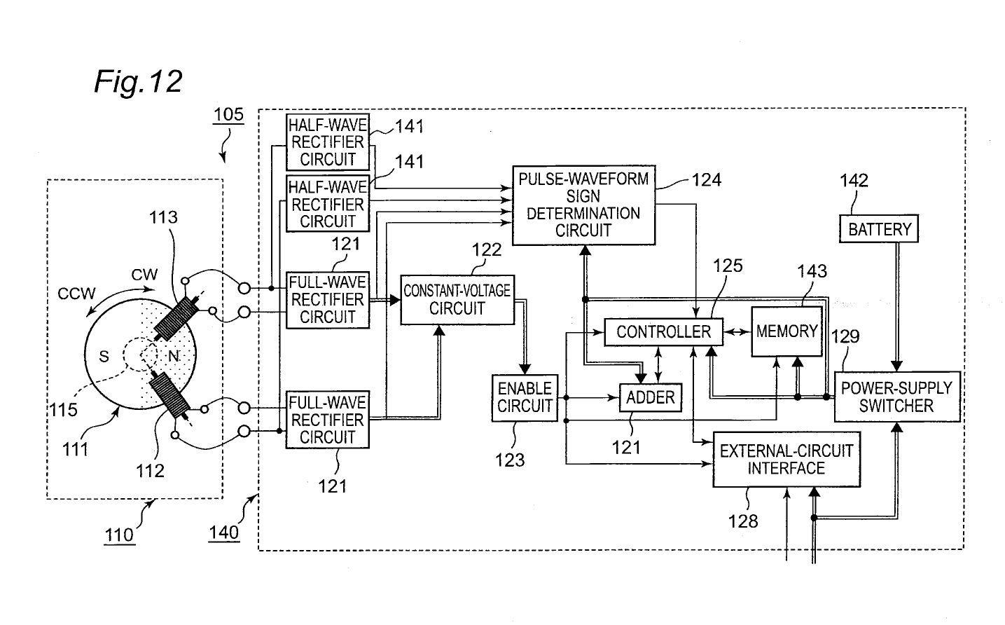

With reference to FIG. 12, there will be described a multi-rotation encoder 105 according to a fifth embodiment of the present invention.

The multi-rotation encoder 105 according to the present embodiment also includes the rotation detection mechanism 110 and a signal processing circuit which is electrically connected to the rotation detection mechanism 110, similarly to the aforementioned battery-less multi-rotation encoders 101 to 103. The multi-rotation encoder 105 according to the present embodiment is different from the aforementioned battery-less multi-rotation encoders 101 to 103 in that it includes a signal processing circuit 140 instead of the signal processing circuits 120, 131 and 132. Further, the signal processing circuit 140 is different from the signal processing circuit 120 in that it is provided with half-wave rectifier circuits 141, further incorporates a battery 142, and includes a memory 143 placed within the signal processing circuit. As described above, the multi-rotation encoder 105 according to the present fifth embodiment is different from the aforementioned battery-less multi-rotation encoders according to the first to fourth embodiments in that it incorporates the battery 142 and, therefore, is not of a battery-less type.

Further, in the signal processing circuit 140 in the multi-rotation encoder 105 according to the present fifth embodiment, the half-wave rectifier circuits 141 are adapted to rectify the respective voltage pulses generated from the detection coils 112 and 113 over their portions corresponding to half the cycle thereof and, further, are adapted to output the rectified voltage pulses to the pulse-waveform sign determination circuit 124. Further, the battery 142 is connected to the power supply switcher 129, and the constant-voltage circuit 122 supplies the constant voltage to only the Enable circuit 123. The other components, which are the adder 121, the pulse-waveform sign determination circuit 124, the controller 125, the external circuit interface 128, and the memory 143, are supplied with electric power from the battery 142 or from the outside through the power supply switcher 129. Along therewith, the memory 143 is not required to be the non-volatile memory and can be the volatile memory. In the present embodiment, the volatile memory is employed.

Further, the other structures in the signal processing circuit 140 are the same as those in the signal processing circuit 120.

With this structure, since the signal processing circuit 140 can be continuously supplied with electric power from the battery 142, the multi-rotation encoder 105 can provide the same effects as those provided by the battery-less multi-rotation encoder 101. Further, it is possible to eliminate the necessity of processes for the non-volatile memory 127 in fabricating the signal processing circuit 140 constituted by integrated circuits. Furthermore, it is possible to eliminate the necessity of driving the signal processing circuit 140 with smaller electric power consumption. Accordingly, with the multi-rotation encoder 105 according to the fifth embodiment, it is possible to decrease the manufacturing cost of the signal processing circuit 140 and to increase the manufacturers thereof in comparison with the case of the battery-less multi-rotation encoder 101. Further, it is possible to employ the general-purpose product as the memory 143, which enables improvement in availability and costs.

Further, it is possible to apply the structures described in the second, third or fourth embodiment to the multi-rotation encoder 105 according to the fifth embodiment.

Further, it is also possible to properly combine arbitrary embodiments out of the aforementioned various embodiments, which can provide the respective effects provided by the respective embodiments.

Although the present invention has been sufficiently described with respect to preferable embodiments with reference to the accompanying drawings, various changes and modifications will be apparent to those skilled in the art. It should be understood that the present invention encompasses such changes and modifications as falling within the scope of the present invention which is defined by the appended claims.

Further, Japanese Patent Application No. 2012-94088, filed on Apr. 17, 2012, and Japanese Patent Application No. 2012-199164, filed on Sep. 11, 2012, are incorporated herein by reference, in the entirety of the disclosures of the specification, the drawings, the claims and the abstract.

### DESCRIPTION OF REFERENCE SYMBOLS

101 to 103 BATTERY-LESS MULTI-ROTATION ENCODER
105 MULTI-ROTATION ENCODER
110 ROTATION DETECTION MECHANISM
111 MAGNET
112, 113 DETECTION COIL
115 ROTATIONAL SHAFT
120 SIGNAL PROCESSING CIRCUIT
121 FULL-WAVE RECTIFIER CIRCUIT
122 CONSTANT-VOLTAGE CIRCUIT
124 PULSE-WAVEFORM SIGN DETERMINATION CIRCUIT
125 CONTROLLER
126 ADDER
127 NON-VOLATILE MEMORY
131, 132, 140 SIGNAL PROCESSING CIRCUIT
142 BATTERY

1. A battery-less multi-rotation encoder adapted to detect and hold a rotational direction of a rotational shaft and a number of rotations of the rotational shaft without being supplied with electric power from outside, the battery-less multi-rotation encoder comprising:
a rotational detection mechanism including a magnet configured to rotate together with the rotational shaft and have N magnetic poles in a circumferential direction of the rotational shaft, and L detection coils configured to have a magnetic wire with the Barkhausen effect with respect to a magnetic field from the magnet and be placed such that their phase angles are deviated from each other on a rotational circumference of the magnet, L being equal to or more than 2; and
a signal processing circuit electrically connected to the rotation detection mechanism,
the signal processing circuit including:
a non-volatile memory circuit adapted to hold a state of the respective detection coils and the number of rotations of the rotational shaft; and
a circuit configured to determine a current state, the rotational direction of the rotational shaft and the number of rotations of the rotational shaft based on four factors which are presence or absence of voltage pulses from the respective detection coils, and positive and negative signs of the voltage pulse waveforms, and based on the state and the number of rotations which have been held in the non-volatile memory circuit and, further, configured to write the new state of the respective coils and the new number of rotations into the non-volatile memory circuit; and
the signal processing circuit further including a voltage circuit configured to generate a voltage for driving the signal processing circuit with the voltage pulses generated from the respective detection coils, and
the signal processing circuit being adapted to determine a rotational angle of the rotational shaft within 1/(LN) rotation unit.

2. The battery-less multi-rotation encoder according to claim 1, wherein two detection coils are placed as the detection coils in such a way as to interpose a phase angle of 90 degrees therebetween.

3. The battery-less multi-rotation encoder according to claim 1, wherein the non-volatile memory is provided separately from the signal processing circuit.

4. The battery-less multi-rotation encoder according to claim 1, wherein
in the rotation detection mechanism, based on a hysteresis angle θ, which is a rotational angle over which the magnetic wire occurs the Barkhausen effect depending on a difference in the rotational direction of the rotational shaft, one or more second detection coils are placed with respect to a single first detection coil such that the phase angle between the first detection coil and the second detection coils falls within an angle range which is larger than the hysteresis angle θ but is smaller than (360/N)−θ.

5. The battery-less multi-rotation encoder according to claim 1, wherein
three or more detection coils are placed as the detection coils on the rotational circumference of the magnet with their phase angles deviated from each other,
the non-volatile memory in the signal processing circuit is adapted to hold the last state and the last but one state of the detection coils, which have been set along with rotations of the magnet,
upon generation of a voltage pulse by any of the detection coils, the signal processing circuit compares it with the coil state having been set based on the last generated voltage pulse, and
with this generated voltage pulse being different from a voltage pulse estimated to be resulted from the movement of the magnet from the rotational position thereof, which is identified by the last coil state, the signal processing circuit corrects the value of the number of rotations or generates an error output based on the last pulse state and the last but one pulse state, and based on this generated voltage pulse.

6. A multi-rotation encoder adapted to detect and hold a rotational direction of a rotational shaft and a number of rotations of the rotational shaft, the multi-rotation encoder comprising:
a rotational detection mechanism including a magnet configured to rotate together with the rotational shaft and have N magnetic poles in a circumferential direction of the rotational shaft, and L detection coils configured to have a magnetic wire with the Barkhausen effect with respect to a magnetic field from the magnet and be placed such that their phase angles are deviated from each other on a rotational circumference of the magnet, L being equal to or more than 2; and
a signal processing circuit electrically connected to the rotation detection mechanism,
the signal processing circuit including:
a memory adapted to hold a state of the respective detection coils and the number of rotations of the rotational shaft; and
a circuit configured to determine a current state, the rotational direction of the rotational shaft and the number of rotations of the rotational shaft based on four factors which are presence or absence of voltage pulses from the respective detection coils, and positive and negative signs of the voltage-pulse waveforms, and based on the state and the number of rotations which have been held in the memory and, further, configured to write the new state of the respective coils and the new number of rotations into the memory; and
the signal processing circuit further including a voltage circuit configured to generate a voltage for driving the signal processing circuit with the voltage pulses generated from the respective detection coils, and
the signal processing circuit being adapted to determine a rotational angle of the rotational shaft within 1/(LN) rotation unit.
